(19) United States
(12) Patent Application Publication
(10) Pub. No.: US 2021/0097278 A1
(43) Pub. Date: Apr. 1, 2021

(54) METHOD AND APPARATUS FOR RECOGNIZING STACKED OBJECTS, AND STORAGE MEDIUM

(71) Applicant: SenseTime International PTE. LTD., Singapore (SG)

(72) Inventors: Yuan LIU, Singapore (SG); Jun HOU, Singapor (SG); Xiaocong CAI, Singapore (SG); Shuai YI, Singapore (SG)

(21) Appl. No.: 16/901,064

(22) Filed: Jun. 15, 2020

Related U.S. Application Data
(63) Continuation of application No. PCT/SG2019/050595, filed on Dec. 3, 2019.

(30) Foreign Application Priority Data
Sep. 27, 2019 (CN) 201910923116.5

(51) Int. Cl. G06K 9/00; G06T 7/11; G06K 9/46; G06K 9/62; G06T 7/60; G06T 7/90; G06T 7/40

(52) U.S. Cl. CPC G06K 9/00624; G06T 7/11; G06K 9/46; G06K 9/6267; G06T 7/60; G06T 2207/10024; G06T 7/40; G06K 9/6217; G06T 2207/20132; G06T 2207/20084; G06T 2207/20081; G06T 7/90

(57) ABSTRACT

The present disclosure relates to a method and apparatus for recognizing stacked objects, an electronic device, and a storage medium. The method for recognizing stacked objects includes: obtaining a to-be-recognized image, wherein the to-be-recognized image includes a sequence formed by stacking at least one object along a stacking direction; performing feature extraction on the to-be-recognized image to obtain a feature map of the to-be-recognized image; and recognizing a category of the at least one object in the sequence according to the feature map. The embodiments of the present disclosure may implement accurate recognition of the category of stacked objects.

The present disclosure is a bypass continuation of and claims priority under 35 U.S.C. § 111(a) to PCT Application. No. PCT/SG2019/050595, filed on Dec. 3, 2019, which claims priority to Chinese Patent Application No. 201910923116.5, filed with the Chinese Patent Office on Sep. 27, 2019, and entitled “METHOD AND APPARATUS FOR RECOGNIZING STACKED OBJECTS, ELECTRONIC DEVICE, AND STORAGE MEDIUM”, which is incorporated herein by reference in its entirety.

### TECHNICAL FIELD

The present disclosure relates to the field of computer vision technologies, and in particular, to a method and apparatus for recognizing stacked objects, an electronic device, and a storage medium.

### BACKGROUND

In related technologies, image recognition is one of the topics that have been widely studied in computer vision and deep learning. However, image recognition is usually applied to the recognition of a single object, such as face recognition and text recognition. At present, researchers are keen on the recognition of stacked objects.

### SUMMARY

The present disclosure provides technical solutions of image processing.

According to a first aspect of the present disclosure, a method for recognizing stacked objects is provided, including:

obtaining a to-be-recognized image, wherein the to-be-recognized image includes a sequence formed by stacking at least one object along a stacking direction;

performing feature extraction on the to-be-recognized image to obtain a feature map of the to-be-recognized image; and

recognizing a category of the at least one object in the sequence according to the feature map.

In some possible implementations, the to-be-recognized image includes an image of a surface of an object constituting the sequence along the stacking direction.

In some possible implementations, the at least one object in the sequence is a sheet-like object.

In some possible implementations, the stacking direction is a thickness direction of the sheet-like object in the sequence.

In some possible implementations, a surface of the at least one object in the sequence along the stacking direction has a set identifier, and the identifier includes at least one of a color, a texture, or a pattern.

In some possible implementations, the to-be-recognized image is cropped from an acquired image, and one end of the sequence in the to-be-recognized image is aligned with one edge of the to-be-recognized image.

In some possible implementations, the method further includes:

in the case of recognizing the category of at least one object in the sequence, determining a total value represented by the sequence according to a correspondence between the category and a value represented by the category.

In some possible implementations, the method is implemented by a neural network, and the neural network includes a feature extraction network and a first classification network;

the performing feature extraction on the to-be-recognized image to obtain a feature map of the to-be-recognized image includes:

performing feature extraction on the to-be-recognized image by using the feature extraction network to obtain the feature map of the to-be-recognized image; and

the recognizing a category of the at least one object in the sequence according to the feature map includes:

determining the category of the at least one object in the sequence by using the first classification network according to the feature map.

In some possible implementations, the neural network further includes a second classification network, a mechanism of the first classification network for classifying the at least one object in the sequence according to the feature map is different from a mechanism of the second classification network for classifying the at least one object in the sequence according to the feature map, and the method further includes:

determining the category of the at least one object in the sequence by using the second classification network according to the feature map; and

determining the category of the at least one object in the sequence based on the category of the at least one object in the sequence determined by the first classification network and the category of the at least one object in the sequence determined by the second classification network.

In some possible implementations, the determining the category of the at least one object in the sequence based on the category of the at least one object in the sequence determined by the first classification network and the category of the at least one object in the sequence determined by the second classification network includes:

in response to the number of object categories obtained by the first classification network being the same as the number of object categories obtained by the second classification network, comparing the category of the at least one object obtained by the first classification network with the category of the at least one object obtained by the second classification network;

in the case that the first classification network and the second classification network have the same predicted category for an object, determining the predicted category as a category corresponding to the object; and

in the case that the first classification network and the second classification network have different predicted categories for an object, determining a predicted category with a higher predicted probability as the category corresponding to the object.

In some possible implementations, the determining the category of the at least one object in the sequence based on the category of the at least one object in the sequence determined by the first classification network and the category of the at least one object in the sequence determined by the second classification network further includes:

in response to the number of the object categories obtained by the first classification network being different from the number of the object categories obtained by the second classification network, determining the category of the at least one object predicted by a classification network with a higher priority in the first classification network and the second classification network as the category of the at least one object in the sequence.

In some possible implementations, the determining the category of the at least one object in the sequence based on the category of the at least one object in the sequence determined by the first classification network and the category of the at least one object in the sequence determined by the second classification network includes:

obtaining a first confidence of a predicted category of the first classification network for the at least one object in the sequence based on the product of predicted probabilities of the predicted category of the first classification network for the at least one object, and obtaining a second confidence of a predicted category of the second classification network for the at least one object in the sequence based on the product of predicted probabilities of the predicted category of the second classification network for the at least one object; and

determining the predicted category of the object corresponding to a larger value in the first confidence and the second confidence as the category of the at least one object in the sequence.

In some possible implementations, a process of training the neural network includes:

performing feature extraction on a sample image by using the feature extraction network to obtain a feature map of the sample image;

determining a predicted category of at least one object constituting a sequence in the sample image by using the first classification network according to the feature map;

determining a first network loss according to the predicted category of the at least one object determined by the first classification network and a labeled category of the at least one object constituting the sequence in the sample image; and

adjusting network parameters of the feature extraction network and the first classification network according to the first network loss.

In some possible implementations, the neural network further includes at least one second classification network, and the process of training the neural network further includes:

determining the predicted category of at least one object constituting the sequence in the sample image by using the second classification network according to the feature map; and

determining a second network loss according to the predicted category of the at least one object determined by the second classification network and the labeled category of the at least one object constituting the sequence in the sample image; and

the adjusting network parameters of the feature extraction network and the first classification network according to the first network loss includes:

adjusting network parameters of the feature extraction network, network parameters of the first classification network, and network parameters of the second classification network according to the first network loss and the second network loss respectively.

In some possible implementations, the adjusting network parameters of the feature extraction network, network parameters of the first classification network, and network parameters of the second classification network according to the first network loss and the second network loss respectively includes:

obtaining a network loss by using a weighted sum of the first network loss and the second network loss, and adjusting parameters of the feature extraction network, the first classification network, and the second classification network based on the network loss, until training requirements are satisfied.

In some possible implementations, the method further includes:

determining sample images with the same sequence as an image group;

obtaining a feature center of a feature map corresponding to sample images in the image group, wherein the feature center is an average feature of the feature map of sample images in the image group; and

determining a third predicted loss according to a distance between the feature map of a sample image in the image group and the feature center; and

the adjusting network parameters of the feature extraction network, network parameters of the first classification network, and network parameters of the second classification network according to the first network loss and the second network loss respectively includes:

obtaining a network loss by using a weighted sum of the first network loss, the second network loss, and the third predicted loss, and adjusting the parameters of the feature extraction network, the first classification network, and the second classification network based on the network loss, until the training requirements are satisfied.

In some possible implementations, the first classification network is a temporal classification neural network.

In some possible implementations, the second classification network is a decoding network of an attention mechanism.

According to a second aspect of the present disclosure, an apparatus for recognizing stacked objects is provided, including:

an obtaining module, configured to obtain a to-be-recognized image, wherein the to-be-recognized image includes a sequence formed by stacking at least one object along a stacking direction;

a feature extraction module, configured to perform feature extraction on the to-be-recognized image to obtain a feature map of the to-be-recognized image; and

a recognition module, configured to recognize a category of the at least one object in the sequence according to the feature map.

In some possible implementations, the to-be-recognized image includes an image of a surface of an object constituting the sequence along the stacking direction.

In some possible implementations, the at least one object in the sequence is a sheet-like object.

In some possible implementations, the stacking direction is a thickness direction of the sheet-like object in the sequence.

In some possible implementations, a surface of the at least one object in the sequence along the stacking direction has a set identifier, and the identifier includes at least one of a color, a texture, or a pattern.

In some possible implementations, the to-be-recognized image is cropped from an acquired image, and one end of the sequence in the to-be-recognized image is aligned with one edge of the to-be-recognized image.

In some possible implementations, the recognition module is further configured to: in the case of recognizing the category of at least one object in the sequence, determine a total value represented by the sequence according to a correspondence between the category and a value represented by the category.

In some possible implementations, the function of the apparatus is implemented by a neural network, the neural network includes a feature extraction network and a first classification network, the function of the feature extraction module is implemented by the feature extraction network, and the function of the recognition module is implemented by the first classification network;

the feature extraction module is configured to: perform feature extraction on the to-be-recognized image by using the feature extraction network to obtain the feature map of the to-be-recognized image; and

the recognition module is configured to: determine the category of the at least one object in the sequence by using the first classification network according to the feature map.

In some possible implementations, the neural network further includes the at least one second classification network, the function of the recognition module is further implemented by the second classification network, a mechanism of the first classification network for classifying the at least one object in the sequence according to the feature map is different from a mechanism of the second classification network for classifying the at least one object in the sequence according to the feature map, and the recognition module is further configured to:

determine the category of the at least one object in the sequence by using the second classification network according to the feature map: and

determine the category of the at least one object in the sequence based on the category of the at least one object in the sequence determined by the first classification network and the category of the at least one object in the sequence determined by the second classification network.

In some possible implementations, the recognition module is further configured to: in the case that the number of object categories obtained by the first classification network is the same as the number of object categories obtained by the second classification network, compare the category of the at least one object obtained by the first classification network with the category of the at least one object obtained by the second classification network;

in the case that the first classification network and the second classification network have the same predicted category for an object, determine the predicted category as a category corresponding to the object; and

in the case that the first classification network and the second classification network have different predicted categories for an object, determine a predicted category with a higher predicted probability as the category corresponding to the object.

In some possible implementations, the recognition module is further configured to: in the case that the number of the object categories obtained by the first classification network is different from the number of the object categories obtained by the second classification network, determine the category of the at least one object predicted by a classification network with a higher priority in the first classification network and the second classification network as the category of the at least one object in the sequence.

In some possible implementations, the recognition module is further configured to: obtain a first confidence of a predicted category of the first classification network for the at least one object in the sequence based on the product of predicted probabilities of the predicted category of the first classification network for the at least one object, and obtain a second confidence of a predicted category of the second classification network for the at least one object in the sequence based on the product of predicted probabilities of the predicted category of the second classification network for the at least one object; and

determine the predicted category of the object corresponding to a larger value in the first confidence and the second confidence as the category of the at least one object in the sequence.

In some possible implementations, the apparatus further includes a training module, configured to train the neural network; the training module is configured to:

perform feature extraction on a sample image by using the feature extraction network to obtain a feature map of the sample image;

determine a predicted category of at least one object constituting a sequence in the sample image by using the first classification network according to the feature map;

determine a first network loss according to the predicted category of the at least one object determined by the first classification network and a labeled category of the at least one object constituting the sequence in the sample image; and

adjust network parameters of the feature extraction network and the first classification network according to the first network loss.

In some possible implementations, the neural network further includes at least one second classification network, and the training module is further configured to:

determine the predicted category of at least one object constituting the sequence in the sample image by using the second classification network according to the feature map; and

determine a second network loss according to the predicted category of the at least one object determined by the second classification network and the labeled category of the at least one object constituting the sequence in the sample image; and the training module configured to adjust the network parameters of the feature extraction network and the first classification network according to the first network loss, is configured to:

adjust network parameters of the feature extraction network, network parameters of the first classification network, and network parameters of the second classification network according to the first network loss and the second network loss respectively.

In some possible implementations, the training module further configured to adjust the network parameters of the feature extraction network, the network parameters of the first classification network, and the network parameters of the second classification network according to the first network loss and the second network loss respectively, is configured to: obtain a network loss by using a weighted sum of the first network loss and the second network loss, and adjust parameters of the feature extraction network, the first classification network, and the second classification network based on the network loss, until training requirements are satisfied.

In some possible implementations, the apparatus further includes a grouping module, configured to determining sample images with the same sequence as an image group; and

a determination module, configured to obtain a feature center of a feature map corresponding to sample images in the image group, wherein the feature center is an average feature of the feature map of sample images in the image group, and determine a third predicted loss according to a distance between the feature map of a sample image in the image group and the feature center; and

the training module further configured to adjust the network parameters of the feature extraction network, the network parameters of the first classification network, and the network parameters of the second classification network according to the first network loss and the second network loss respectively, is configured to: obtain a network loss by using a weighted sum of the first network loss, the second network loss, and the third predicted loss, and adjust the parameters of the feature extraction network, the first classification network, and the second classification network based on the network loss, until the training requirements are satisfied.

In some possible implementations, the first classification network is a temporal classification neural network.

In some possible implementations, the second classification network is a decoding network of an attention mechanism.

According to a third aspect of the present disclosure; an electronic device is provided, including:

a processor; and

a memory configured to store processor executable instructions;

wherein the processor is configured to: invoke the instructions stored in the memory to execute the method according to any item in the first aspect.

According to a fourth aspect of the present disclosure, a computer-readable storage medium is provided, which has computer program instructions stored thereon, wherein when the computer program instructions are executed by a processor, the foregoing method according to any item in the first aspect is implemented.

In the embodiments of the present disclosure, a feature map of a to-be-recognized image may be obtained by performing feature extraction on the to-be-recognized image, and the category of each object in a sequence consisting of stacked objects to-be-recognized imaged is obtained according to classification processing of the feature map. By means of the embodiments of the present disclosure, stacked objects in an image may be classified and recognized conveniently and accurately.

It should be understood that the foregoing general descriptions and the following detailed descriptions are merely exemplary and explanatory, but are not intended to limit the present disclosure.

Exemplary embodiments are described in detail below according to the following reference accompanying drawings, and other features and aspects of the present disclosure become clear.

### BRIEF DESCRIPTION OF THE DRAWINGS

The accompanying drawings here are incorporated into the specification and constitute a part of the specification. These accompanying drawings show embodiments that conform to the present disclosure, and are intended to describe the technical solutions in the present disclosure together with the specification.

FIG. 1 is a flowchart of a method for recognizing stacked objects according to embodiments of the present disclosure;

FIG. 2 is a schematic diagram of a to-be-recognized image according to embodiments of the present disclosure;

FIG. 3 is another schematic diagram of a to-be-recognized image according to embodiments of the present disclosure;

FIG. 4 is a flowchart of determining object categories in a sequence based on classification results of a first classification network and a second classification network according to embodiments of the present disclosure;

FIG. 5 is another flowchart of determining object categories in a sequence based on classification results of a first classification network and a second classification network according to embodiments of the present disclosure;

FIG. 6 is a flowchart of training a neural network according to embodiments of the present disclosure;

FIG. 7 is a flowchart of lining a first network loss according to embodiments of the present disclosure;

FIG. 8 is a flowchart of determining a second network loss according to embodiments of the present disclosure;

FIG. 9 is a block diagram of an apparatus for recognizing stacked objects according to embodiments of the present disclosure;

FIG. 10 is a block diagram of an electronic device according to embodiments of the present disclosure; and

FIG. 11 is a block diagram of another electronic device according to embodiments of the present disclosure.

### DETAILED DESCRIPTION

The following describes various exemplary embodiments, features, and aspects of the present disclosure in detail with reference to the accompanying drawings. Same reference numerals in the accompanying drawings represent elements with same or similar functions. Although various aspects of the embodiments are illustrated in the accompanying drawings, the accompanying drawings are not necessarily drawn in proportion unless otherwise specified.

The special term “exemplary” here refers to “being used as an example, an embodiment, or an illustration”. Any embodiment described as “exemplary” here should not be explained as being more superior or better than other embodiments.

The term “and/or” herein describes only an association relationship describing associated objects and represents that three relationships may exist. For example, A and/or B may represent the following three cases: only A exists, both A and B exist, and only B exists. In addition, the term “at least one” herein indicates any one of multiple listed items or any combination of at least two of multiple listed items. For example, including at least one of A, B, or C may indicate including any one or more elements selected from a set consisting of A, B, and C.

In addition, for better illustration of the present disclosure, various specific details are given in the following specific implementations. A person skilled in the art should understand that the present disclosure may also be implemented without the specific details. In some instances, methods, means, elements, and circuits well known to a person skilled in the art are not described in detail so as to highlight the subject matter of the present disclosure.

The embodiments of the present disclosure provide a method for recognizing stacked objects, which can effectively recognize a sequence consisting of objects included in a to-be-recognized image and determine categories of the objects, wherein the method may be applied to any image processing apparatus, for example, the image processing apparatus may include a terminal device and a server, wherein the terminal device may include User Equipment (UE), a mobile device, a user terminal, a terminal, a cellular phone, a cordless phone, a Personal Digital Assistant (PDA), a handheld device, a computing device, a vehicle-mounted device, a wearable device, and the like. The server may be a local server or a cloud server. In some possible implementations, the method for recognizing stacked objects may be implemented by a processor by invoking computer-readable instructions stored in a memory. Any device may be the execution subject of the method for recognizing stacked objects in the embodiments of the present disclosure as long as said device can implement image processing.

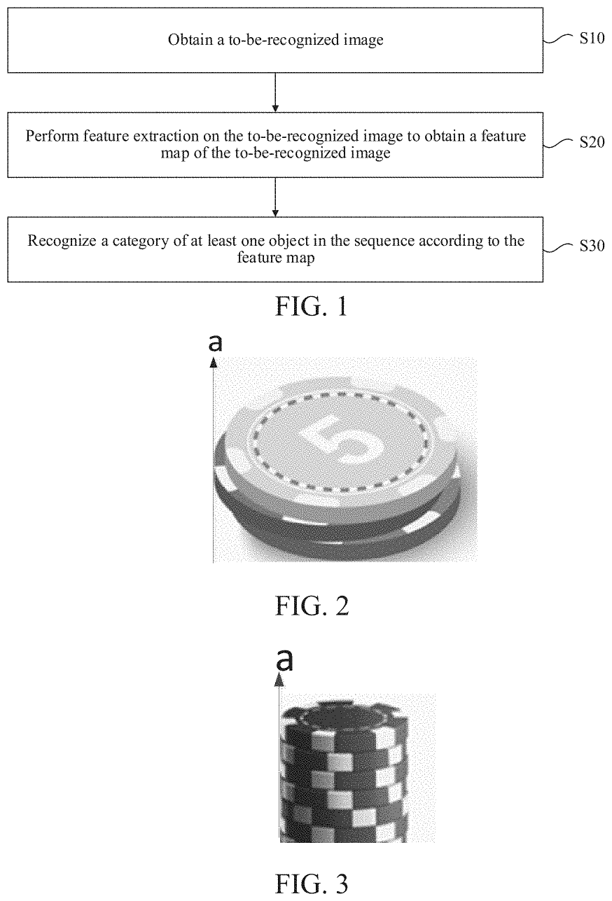

FIG. 1 is a flowchart of a method for recognizing stacked objects according to embodiments of the present disclosure. As shown in FIG. 1, the method includes the following steps.

At S10: a to-be-recognized image is obtained, wherein the to-be-recognized image includes a sequence formed by stacking at least one object along a stacking direction.

In some possible implementations, the to-be-recognized image may be an image of the at least one object, and moreover, each object in the image may be stacked along one direction to constitute an object sequence (hereinafter referred to as a sequence). The to-be-recognized image includes an image of a surface of an object constituting the sequence along the stacking direction. That is, the to-be-recognized image may be an image showing a stacked state of objects, and a category of each object is obtained by recognizing each object in the stacked state. For example, the method for recognizing stacked objects in the embodiments of the present disclosure may be applied in a game, entertainment, or competitive scene, and the objects include game currencies, game cards, game chips and the like in this scene. No specific limitation is made thereto in the present disclosure. FIG. 2 is a schematic diagram of a to-be-recognized image according to embodiments of the present disclosure, and FIG. 3 is another schematic diagram of a to-be-recognized image according to embodiments of the present disclosure. A plurality of objects in a stacked state may be included therein, a direction indicates the stacking direction, and the plurality of objects form a sequence. In addition, the objects in the sequence in the embodiments of the present disclosure may be irregularly stacked together as shown in FIG. 2, and may also be evenly stacked together as shown in FIG. 3. The embodiments of the present disclosure may be comprehensively applied to different images and have good applicability.

In some possible embodiments, the objects in the to-be-recognized image may be sheet-like objects, and the sheet-like objects have a certain thickness. The sequence is formed by stacking the sheet-like objects together. The thickness direction of the objects may be the stacking direction of the objects. That is, the objects may be stacked along the thickness direction of the objects to form the sequence.

In some possible implementations, a surface of the at least one object in the sequence along the stacking direction has a set identifier. In the embodiments of the present disclosure, there may be different identifiers on side surfaces of the objects in the to-be-recognized image, for distinguishing different objects, wherein the side surfaces are side surfaces in a direction perpendicular to the stacking direction. The set identifier may include at least one or more of set color, patter, texture, and numerical value. In one example, the objects may be game chips, and the to-be-recognized image may be an image in which a plurality of gaming chips is stacked in the longitudinal direction or the horizontal direction. Because the game chips have different code values, at least one of the colors, patterns, or code value symbols of the chips with different code values may be different. In the embodiments of the present disclosure, according to the obtained to-be-recognized image including at least one chip, the category of the code value corresponding to the chip in the to-be-recognized image may be detected to obtain a code value classification result of the chip.

In some possible implementations, the approach of obtaining the to-be-recognized image may include acquiring a to-be-recognized image in real time by means of an image acquisition device, for example, playgrounds, arenas or other places may be equipped with image acquisition devices. In this case, the to-be-recognized image may be directly acquired by means of the image acquisition device. The image acquisition device may include a camera lens, a camera, or other devices capable of acquiring information such as images and videos. In addition, the approach of obtaining the to-be-recognized image may also include receiving a to-be-recognized image transmitted by other electronic devices or reading a stored to-be-recognized image. That is, a device that executes the method for recognizing stacked objects by means of the chip sequence recognition in the embodiments of the present disclosure may be connected to other electronic devices by communication, to receive the to-be-recognized image transmitted by the electronic devices connected thereto, or may also select the to-be-recognized image from a storage address based on received selection information. The storage address may be a local storage address or a storage address in a network.

In some possible implementations, the to-be-recognized image may be cropped from an image acquired (hereinafter referred to as the acquired image). The to-be-recognized image may be at least a part of the acquired image, and one end of the sequence in the to-be-recognized image is aligned with one edge of the to-be-recognized image. In the case of the acquired image, the acquired image obtained may include, in addition to the sequence constituted by the objects, other information in the scene, for example, the image may include people, a desktop, or other influencing factors. In the embodiments of the present disclosure, the acquired image may be preprocessed before processing the acquired image, for example, segmentation may be performed on the acquired image. By means of the segmentation, a to-be-recognized image including a sequence may be captured from the acquired image, and at least one part of the acquired image may also be determined as a to-be-recognized image; moreover, one end of the sequence in the to-be-recognized image is aligned with the edge of the image, and the sequence is located in the to-be-recognized image. As shown in FIGS. 2 and 3, one end on the left side of the sequence is aligned with the edge of the image. In other embodiments, it is also possible to align each end of the sequence in the to-be-recognized image with each edge of the to-be-recognized image, so as to comprehensively reduce the influence of factors other than objects in the image.

At S20, feature extraction is performed on the to-be-recognized image to obtain a feature map of the to-be-recognized image.

In the case that the to-be-recognized image is obtained, feature extraction may be performed on the to-be-recognized image to obtain a corresponding feature map. The to-be-recognized image may be input to a feature extraction network, and the feature map of the to-be-recognized image may be extracted through the feature extraction network. The feature map may include feature information of at least one object included in the to-be-recognized image. For example, the feature extraction network in the embodiments of the present disclosure may be a convolutional neural network, at least one layer of convolution processing is performed on the input to-be-recognized image through the convolutional neural network to obtain the corresponding feature map, wherein after the convolutional neural network is trained, the feature map of object features in the to-be-recognized image can be extracted. The convolutional neural network may include a residual convolutional neural network, a Visual Geometry Group Network (VGG), or any other convolutional neural network. No specific limitation is made thereto in the present disclosure. As long as the feature map corresponding to the to-be-recognized image can be obtained, it can be used as the feature extraction network in the embodiments of the present disclosure.

At S30: A category of the at least one object is recognized in the sequence according to the feature map.

In some possible implementations, in the case that the feature map of the to-be-recognized image is obtained, classification processing of the objects in the to-be-recognized image may be performed by using the feature map. For example, at least one of the number of objects in the sequence and the identifiers of the objects in the to-be-recognized image may be recognized. The feature map of the to-be-recognized image may be further input to a classification network for classification processing to obtain the category of the objects in the sequence.

In some possible implementations, the objects in the sequence may be the same objects, for example, the features such as patterns, colors, textures, or sizes of the objects are all the same. Alternatively, the objects in the sequence may also be different objects, and the different objects are different in at least one of pattern, size, color, texture, or other features. In the embodiments of the present disclosure, in order to facilitate distinguishing and recognizing the objects, category identifiers may be assigned to the objects, the same objects have the same category identifiers, and different objects have different category identifiers. As stated in the foregoing embodiments, the category of the object may be obtained by performing classification processing on the to-be-recognized image, wherein the category of the object may be the number of objects in the sequence, or the category identifiers of the objects in the sequence, and may also be the category identifiers and number corresponding to the object. The to-be-recognized image may be input into the classification network to obtain a classification result of the above-mentioned classification processing.

In one example, in the case that the category identifier corresponding to the object in the to-be-recognized image is known in advance, only the number of objects may be recognized through the classification network, and in this case, the classification network may output the number of objects in the sequence in the to-be-recognized image. The to-be-recognized image may be input to the classification network, and the classification network may be a convolutional neural network that can be trained to recognize the number of stacked objects. For example, the objects are game currencies in a game scene, and each game currency is the same. In this case, the number of game currencies in the to-be-recognized image may be recognized through the classification network, which is convenient for counting the number of the game currencies and the total value of the currencies.

In one example, both the category identifiers and the number of the objects are unclear. However, in the case that the objects in the sequence are the same objects, the category identifiers and the number of the objects may be simultaneously recognized through classification, and in this case, the classification network may output the category identifiers and the number of the objects in the sequence. The category identifiers output by the classification network represent the identifiers corresponding to the objects in the to-be-recognized image, and the number of objects in the sequence may also be output. For example, the objects may be game chips. The game chips in the to-be-recognized image may have the same code values, that is, the game chips may be the same chips. The to-be-recognized image may be processed through the classification network, to detect the features of the game chips, and recognize the corresponding category identifiers, as well as the number of the game chips. In the foregoing embodiments, the classification network may be a convolutional neural network that can be trained to recognize the category identifiers and the number of objects in the to-be-recognized image. With this configuration, it is convenient to recognize the identifiers and number corresponding to the objects in the to-be-recognized image.

In one example, in the case that at least one object in the sequence of the to-be-recognized image is different from the remaining objects, for example, different in at least one of the color, pattern or texture, the category identifiers of the objects may be recognized by using the classification network, and in this case, the classification network may output the category identifiers of the objects in the sequence to determine and distinguish the objects in the sequence. For example, the objects may be game chips, the chips with different code values may different in color, patter or texture. In this case, different chips may have different identifiers, and the features of the objects are detected by processing the to-be-recognized image through the classification network, to obtain the category identifiers of the objects accordingly. Alternatively, furthermore, the number of objects in the sequence may also be output. In the foregoing embodiments, the classification network may be a convolutional neural network that can be trained to recognize the category identifiers of the objects in the to-be-recognized image. With this configuration, it is convenient to recognize the identifiers and number corresponding to the objects in the to-be-recognized image.

In some possible implementations, the category identifiers of the objects may be values corresponding to the objects. Alternatively, in the embodiments of the present disclosure, a mapping relationship between the category identifiers of the objects and the corresponding values may also be configured. By means of the recognized category identifiers, the values corresponding to the category identifiers may be further obtained, thereby determining the value of each object in the sequence. In the case that the category of each object in the sequence of the to-be-recognized image is obtained, a total value represented by the sequence in the to-be-recognized image may be determined according to a correspondence between the category of each object in the sequence and a representative value, and the total value of the sequence is the sum of the values of the objects in the sequence. Based on this configuration, the total value of the stacked objects may be conveniently counted, for example, it is convenient to detect and determine the total value of stacked game currencies and game chips.

Based on the above-mentioned configuration, in the embodiments of the present disclosure, the stacked objects in the image may be classified and recognized conveniently and accurately.

The following describes each process in the embodiments of the present disclosure respectively in combination with the accompanying drawings. Firstly, a to-be-recognized image is obtained, as stated in the foregoing embodiments, the obtained to-be-recognized image may be an image obtained by preprocessing the acquired image. Target detection may be performed on the acquired image by means of a target detection neural network. A detection bounding box corresponding to a target object in the acquired image may be obtained by means of the target detection neural network. The target object may be an object in the embodiments of the present disclosure, such as a game currency, a game chip, or the like. An image region corresponding to the obtained detection bounding box may be the to-be-recognized image, or it may also be considered that the to-be-recognized image is selected from the detection bounding box. In addition, the target detection neural network may be a region candidate network.

The above is only an exemplary description, and no specific limitation is made thereto in the present disclosure.

In the case that the to-be-recognized image is obtained, feature extraction may be performed on the to-be-recognized image. In the embodiments of the present disclosure, feature extraction may be performed on the to-be-recognized image through a feature extraction network to obtain a corresponding feature map. The feature extraction network may include a residual network or any other neural network capable of performing feature extraction. No specific limitation is made thereto in the present disclosure.

In the case that the feature map of the to-be-recognized image is obtained, classification processing may be performed on the feature map to obtain the category of each object in the sequence.

In some possible implementations, the classification processing may be performed through a first classification network, and the category of the at least one object in the sequence is determined according to the feature map by using the first classification network. The first classification network may be a convolutional neural network that can be trained to recognize feature information of an object in the feature map, thereby recognizing the category of the object, for example, the first classification network may be a Connectionist Temporal Classification (CTC) neural network, a decoding network based on an attention mechanism or the like.

In one example, the feature map of the to-be-recognized image may be directly input to the first classification network, and the classification processing is performed on the feature map through the first classification network to obtain the category of the at least one object of the to-be-recognized image. For example, the objects may be game chips, and the output categories may be the categories of the game chips, and the categories may be the code values of the game chips. The code values of the chips corresponding to the objects in the sequence may be sequentially recognized through the first classification network, and in this case, the output result of the first classification network may be determined as the categories of the objects in the to-be-recognized image.

In some other possible implementations, according to the embodiments of the present disclosure, it is also possible to perform classification processing on the feature map of the to-be-recognized image through the first classification network and the second classification network, respectively. The category of the at least one object in the sequence is finally determined through the categories of the at least one object in the sequence of the to-be-recognized image respectively predicted by the first classification network and the second classification network and based on the category of the at least one object in the sequence determined by the first classification network and the category of the at least one object in the sequence determined by the second classification network.

In the embodiments of the present disclosure, the final category of each object in the sequence may be obtained in combination with the classification result of the second classification network for the sequence of the to-be-recognized image, so that the recognition accuracy can be further improved. After a special map of the to-be-recognized image is obtained; the feature map may be input to the first classification network and the second classification network, respectively, A first recognition result of the sequence is obtained through the first classification network, and the classification result includes a predicted category of each object in the sequence and a corresponding predicted probability. A second recognition is obtained through the second classification network, and the second recognition includes a predicted category of each object in the sequence and a corresponding predicted probability. The first classification network may be CTC neural network, and the corresponding second classification network may be a decoding network of an attention mechanism. Alternatively, in some other embodiments, the first classification network may be the decoding network of the attention mechanism, and the corresponding second classification network may be the CTC neural network. However, no specific limitation is made thereto in the present disclosure. These may be classification networks of other types.

Further, based on the classification result of the sequence obtained by the first classification network and the sequence obtained by the second classification network, the final category of each object in the sequence, i.e., the final classification result, may be obtained.

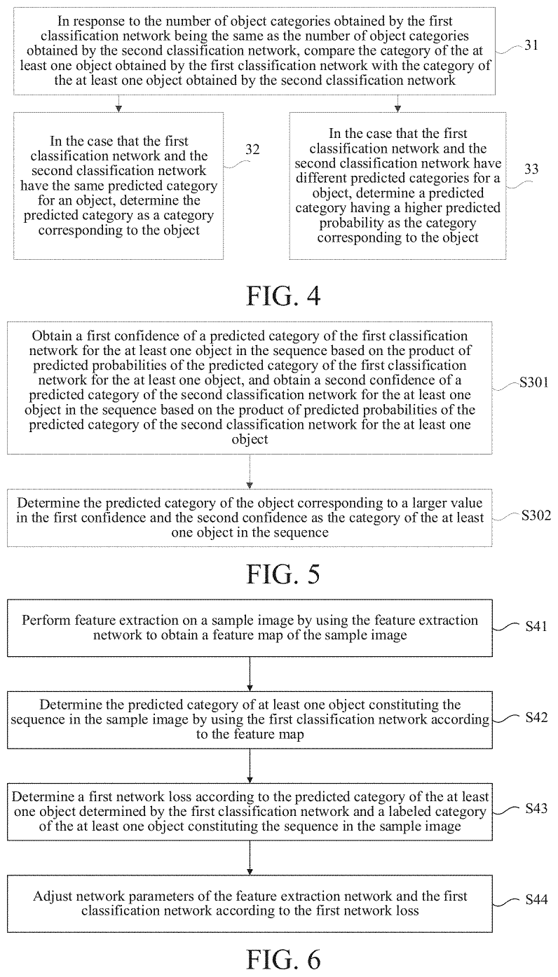

FIG. 4 is a flowchart of determining object categories in a sequence based on classification results of a first classification network and a second classification network according to embodiments of the present disclosure, wherein determining the category of the at least one object in the sequence based on the category of the at least one object in the sequence determined by the first classification network and the category of the at least one object in the sequence determined by the second classification network may include:

S31: in response to the number of object categories obtained through prediction by the first classification network being the same as the number of object categories obtained through prediction by the second classification network, comparing the category of the at least one object obtained by the first classification network with the category of the at least one object obtained by the second classification network;

S32: in the case that the first classification network and the second classification network have the same predicted category for an object, determining the predicted category as a category corresponding to the object; and

S33: in the case that the first classification network and the second classification network have different predicted categories for an object, determining a predicted category with a higher predicted probability as the category corresponding to the object.

In some possible implementations, it is possible to compare whether the numbers of object categories in the sequence in the first recognition result obtained by the first classification network and in the second recognition result obtained by the second classification network are the same, that is, whether the predicted numbers of the objects are the same. If yes, the predicted categories of the two classification networks for each object can be compared in turn. That is, if the number of categories in the sequence obtained by the first classification network is the same as the number of categories in the sequenced obtained by the second classification network, for the same object, if the predicted categories are the same, then the same predicted category may be determined as the category of a corresponding object. If there is a case in which the predicted categories of the object are different, the predicted category having a higher predicted probability may be determined as the category of the object. It should be explained here that, the classification networks (the first classification network and the second classification network) may also obtain a predicted probability corresponding to each predicted category while obtaining the predicted category of each object in the sequence of the to-be-recognized image by performing classification processing on the to-be-recognized image. The predicted probability may represent the possibility that the object is of a corresponding predicted category.

For example, in the case that the objects are chips, in the embodiments of the present disclosure, the category (such as the code value) of each chip in the sequence obtained by the first classification network and the category (such as the code value) of each chip in the sequence obtained by the second classification network may be compared. In the case that the first recognition result obtained by the first classification network and the second recognition result obtained by the second classification network have the same predicted code value for a same chip, the predicted code value is determined as a code value corresponding to the same chip; and in the case that a first chip sequence obtained by the first classification network and a chip sequence obtained by the second classification network have different predicted code values for the same chip, the predicted code value having a higher predicted probability is determined as the code value corresponding to the same chip. For example, the first recognition result obtained by the first classification network is “112234”, and the second recognition result obtained by the second classification network is “112236”, wherein each number respectively represents the category of each object. Therefore, if the predicted categories of the first five objects are the same, it can be determined that the categories of the first five objects are “11223”; for the prediction of the category of the last object, the predicted probability obtained by the first classification network is A, and the predicted probability obtained by the second classification network is B. In the case that A is greater than B, “4” may be determined as the category of the last object; in the case that B is greater than A, “6” may be determined as the category corresponding to the last object.

After the category of each object is obtained, the category of each object may be determined as the final category of the object in the sequence. For example, when the objects in the foregoing embodiments are chips, if A is greater than B, “112234” may be determined as a final chip sequence; if B is greater than A, “112236” may be determined as the final chip sequence. In addition, for a case in which A is equal to B, the two cases may be simultaneously output, that is, the both cases are used as the final chip sequence.

In the above manner, the final object category sequence may be determined in the case that the number of categories of the objects recognized in the first recognition result and the number of categories of the objects recognized in the second recognition result are the same, and has the characteristic of high recognition accuracy.

In some other possible implementations, the numbers of categories of the objects obtained by the first recognition result and the second recognition result may be different. In this case, the recognition result of a network with a higher priority in the first classification network and the second classification network may be used as the final object category. In response to the number of the object categories in the sequence obtained by the first classification network being different from the number of the object categories in the sequence obtained by the second classification network, the object category obtained through prediction by a classification network with a higher priority in the first classification network and the second classification network is determined as the category of the at least one object in the sequence in the to-be-recognized image.

In the embodiments of the present disclosure, the priorities of the first classification network and the second classification network may be set in advance. For example, the priority of the first classification network is higher than that of the second classification network. In the case where the numbers of object categories in the sequence in the first recognition result and the second recognition result are different, the predicted category of each object in the first recognition result of the first classification network is determined as the final object category; on the contrary, if the priority of the second classification network is higher than that of the first classification network, the predicted category of each object in the second recognition result obtained by the second classification network may be determined as the final object category. Through the above, the final object category may be determined according to pre-configured priority information, wherein the priority configuration is related to the accuracy of the first classification network and the second classification network. When implementing the classification and recognition of different types of objects, different priorities may be set, and a person skilled in the art may set the priorities according to requirements. Through the priority configuration, an object category with high recognition accuracy may be conveniently selected.

In some other possible implementations, it is also possible not to compare the numbers of object categories obtained by the first classification network and the second classification network, but to directly determine the final object category according to a confidence of the recognition result. The confidence of the recognition result may be the product of the predicted probability of each object category in the recognition result. For example, the confidences of the recognition results obtained by the first classification network and the second classification network may be calculated respectively, and the predicted category of the object in the recognition result having a higher confidence is determined as the final category of each object in the sequence.

FIG. 5 is another flowchart of determining object categories in a sequence based on classification results of a first classification network and a second classification network according to embodiments of the present disclosure. The determining the category of the at least one object in the sequence based on the category of the at least one object in the sequence determined by the first classification network and the category of the at least one object in the sequence determined by the second classification network may further include:

S301: obtaining a first confidence of a predicted category of the first classification network for the at least one object in the sequence based on the product of predicted probabilities of the predicted category of the first classification network for the at least one object, and obtaining a second confidence of a predicted category of the second classification network for the at least one object in the sequence based on the product of predicted probabilities of the predicted category of the second classification network for the at least one object; and

S302: determining the predicted category of the object corresponding to a larger value in the first confidence and the second confidence as the category of the at least one object in the sequence.

In some possible implementations, based on the product of the predicted probability corresponding to the predicted category of each object in a first recognition result obtained by the first classification network, the first confidence of the first recognition result may be obtained, and based on the product of the predicted probability corresponding to the predicted category of each object in a second recognition result obtained by the second classification network, the second confidence of the second recognition result may be obtained; subsequently, the first confidence and the second confidence may be compared, and the recognition result corresponding to a larger value in the first confidence and the second confidence is determined as the final classification result, that is, the predicted category of each object in the recognition result having a higher confidence is determined as the category of each object in the to-be-recognized image.

In one example, the objects are game chips, and the categories of the objects may, represent code values. The categories corresponding to the chips in the to-be-recognized image obtained by the first classification network may be “123” respectively, wherein the probability of the code value 1 is 0.9, the probability of the code value 2 is 0.9, and the probability of the code value 3 is 0.8, and thus, the first confidence may be 0.9*0.9*0.8, i.e., 0.648. The object categories obtained by the second classification network may be “1123” respectively, wherein the probability of the first code value 1 is 0.6, the probability of the second code value 1 is 0.7, the probability of the code value 2 is 0.8, and the probability of the code value 3 is 0.9, and thus, the second confidence is 0.6*0.7*0.8*0.9, i.e., 0.3024. Because the first confidence is greater than the second confidence, the code value sequence “123” may be determined as the final category of each object. The above is only an exemplary description and is not intended to be a specific limitation. This approach does not need to adopt different approaches to determine the final object category according to the number of dependent categories of the object, and has the characteristics of simplicity and convenience.

Through the foregoing embodiments, in the embodiments of the present disclosure, quick detection and recognition of each object category in the to-be-recognized image may be performed according to one classification network, and two classification networks may also be simultaneously used for joint monitoring to implement accurate prediction of object categories.

Below, a training structure of a neural network that implements the method for recognizing stacked objects according to embodiments of the present disclosure is described. The neural network in the embodiments of the present disclosure may include a feature extraction network and a classification network. The feature extraction network may implement feature extraction processing of a to-be-recognized image, and the classification network may implement classification processing of a feature map of the to-be-recognized image. The classification network may include a first classification network, or may also include the first classification network and at least one second classification network. The following training process is described by taking the first classification network being a temporal classification neural network and the second classification network being a decoding network of a convolution mechanism as an example, but is not intended to be a specific limitation of the present disclosure.

FIG. 6 is a flowchart of training a neural network according to embodiments of the present disclosure, wherein a process of training the neural network includes:

S41: performing feature extraction on a sample image by using the feature extraction network to obtain a feature map of the sample image;

S42: determining a predicted category of at least one object constituting the sequence in the sample image by using the first classification network according to the feature map;

S43: determining a first network loss according to the predicted category of the at least one object determined by the first classification network and a labeled category of the at least one object constituting the sequence in the sample image; and

S44: adjusting network parameters of the feature extraction network and the first classification network according to the first network loss.

In some possible implementations, the sample image is an image used for training a neural network, and may include a plurality of sample images. The sample image may be associated with a labeled real object category, for example, the sample image may be a chip stacking image, in which real code values of the chips are labeled. The approach of obtaining the sample image may be receiving a transmitted sample image by means of communication, or reading a sample image stored in a storage address. The above is only an exemplary description, and is not intended to be a specific limitation of the present disclosure.

When training a neural network, the obtained sample image may be input to a feature extraction network, and a feature map corresponding to the sample image may be obtained through the feature extraction network. Said feature map is hereinafter referred to as a predicted feature map. The predicted feature map is input to a classification network, and the predicted feature map is processed through the classification network to obtain a predicted category of each object in the sample image. Based on the predicted category of each object of the sample image obtained by the classification network, the corresponding predicted probability, and the labeled real category, the network loss may be obtained.

The classification network may include a first classification network. A first prediction result is obtained by performing classification processing on the predicted feature map of the sample image through the first classification network. The first prediction result indicates the obtained predicted category of each object in the sample image. A first network loss may be determined based on the predicted category of each object obtained by prediction and a labeled category of each object obtained by annotation. Subsequently, parameters of the feature extraction network and the classification network in the neural network, such as convolution parameters, may be adjusted according to first network loss feedback, to continuously optimize the feature extraction network and the classification network, so that the obtained predicted feature map is more accurate and the classification result is more accurate. Network parameters may be adjusted if the first network loss is greater than a loss threshold. If the first network loss is less than or equal to the loss threshold, it indicates that the optimization condition of the neural network has been satisfied, and in this case, the training of the neural network may be terminated.

Alternatively, the classification network may include the first classification network and at least one second classification network. In common with the first classification network, the second classification network may also perform classification processing on the predicted feature map of the sample image to obtain a second prediction result, and the second prediction result may also indicate the predicted category of each object in the sample image. Each second classification network may be the same or different, and no specific limitation is made thereon in the present disclosure. A second network loss may be determined according to the second prediction result and the labeled category of the sample image. That is, the predicted feature map of the sample image obtained by the feature extraction network may be input to the first classification network and the second classification network respectively. The first classification network and the second classification network simultaneously perform classification prediction on the predicted feature map to obtain corresponding first prediction result and second prediction result, and the first network loss of the first classification network and the second network loss of the second classification network are obtained by using respective loss functions. Then, an overall network loss of the network may be determined according to the first network loss and the second network loss, parameters of the feature extraction network, the first classification network and the second classification network, such as convolution parameters and parameters of a fully connected layer, are adjusted according to the overall network loss, so that the final overall network loss of the network is less than the loss threshold. In this case, it is determined that the training requirements are satisfied, that is, the training requirements are satisfied until the overall network loss is less than or equal to the loss threshold.

The determination process of the first network loss, the second network loss, and the overall network loss is described in detail below.

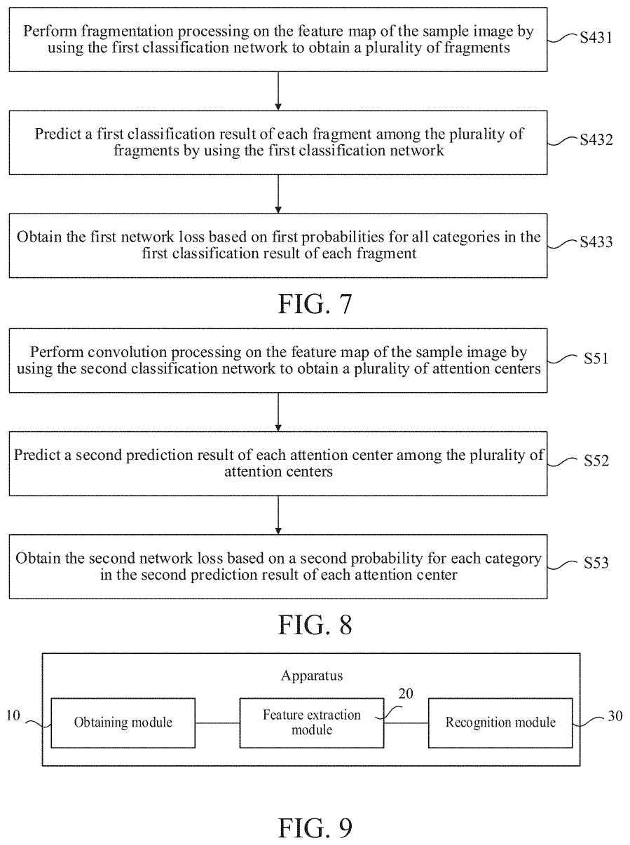

FIG. 7 is a flowchart of determining a first network loss according to embodiments of the present disclosure, wherein the process of determining the first network loss may include the following steps.

At S431, fragmentation processing is performed on a feature map of the first sample image by using the first classification network, to obtain a plurality of fragments.

In some possible implementations, in a process of recognizing the categories of stacked objects, a CTC network needs to perform fragmentation processing on a special map of the sample image, and separately predict the object category corresponding to each fragment. For example, in the case that the sample image is a chip stacking image and the object category is the code value of a chip. When the code value of the chip is predicted through the first classification network, it is necessary to perform fragmentation processing on the feature map of the sample image, wherein the feature map may be fragmented in the transverse direction or the longitudinal direction to obtain a plurality of fragments. For example, the width of the feature map X of the sample image is W and the predicted feature map X is equally divided into W (W is a positive integer) parts in the width direction, i.e., X=[x₁,x₂, . . . ,x_{w}], each Xᵢ (1≤i≤W, and i is an integer) in the X is each fragment feature of the feature map X of the sample image.

At S432: a first classification result of each fragment among the plurality of fragments is predicted by using the first classification network.

After performing fragmentation processing on the feature map of the sample image, a first classification result corresponding to each fragment may be obtained. The first classification result may include a first probability that an object in each segment is of each category, that is, a first probability that each fragment is of all possible categories may be calculated. Taking chips as an example, the first probability of the code value of each chip relative to the code value of each chip may be obtained. For example, the number of code values may be three, and the corresponding code values may be “1”, “5”, and “10”, respectively, Therefore, when performing classification prediction on each fragment, a first probability that each fragment is of each code value “1”, “5”, and “1.0” may be obtained. Accordingly, for each fragment in the feature map X, there may correspondingly be a first probability Z of each category, wherein Z represents a set of first probabilities of each fragment for each category, and Z may be expressed as Z=[z₁,z₂, . . . ,z_{w}], where each z represents a set of first probabilities of the corresponding fragment xᵢ for each category.

At S433, the first network loss is obtained based on the first probabilities for all categories in the first classification result of each fragment.

In some possible implementations, the first classification network is set with the distribution of prediction categories corresponding to real categories, that is, a one-to-many mapping relationship may be established between the sequence consisting of the actual labeled categories of each object in the sample image and the distribution of corresponding possible predicted categories thereof. The mapping relationship may be expressed as C=B (Y), where Y represents the sequence consisting of the real labeled categories, and C represents a set C=(c1, c2, . . . , cn) of n (n is a positive integer) possible category distribution sequences corresponding to Y, for example, for the real labeled category sequence “123”, the number of fragments is 4, and the predicted possible distribution C may include “1123”, “1223”, “1233”, and the like. Accordingly, cj is the j-th possible category distribution sequence for the real labeled category sequence (j is an integer greater than or equal to 1 and less than or equal to n, and n is the number of possible rows in the category distribution).

Therefore, according to the first probability of the category corresponding to each fragment in the first prediction result, the probability of each distribution may be obtained, so that the first network loss may be determined, wherein the expression of the first network loss may be:

$${L}_{1} = - log P ( Y \vert Z ) \text{;}$$

$$P ( Y \vert Z ) = {\sum }_{cj ∈ {B}^{- 1} ( Y )} p ( cj \vert Z ) \text{;}$$

where L1 represents the first network loss, P(Y|Z) represents the probability of a probability distribution sequence of the predicted categories of the real labeled category sequence Y, where p(cj|Z) is the product of the first probabilities of each category in the distribution for cj.

Through the above, the first network loss may be conveniently obtained. The first network loss may comprehensively reflect the probability of each fragment of the first network loss for each category, and the prediction is more accurate and comprehensive.

FIG. 8 is a flowchart of determining a second network loss according to embodiments of the present disclosure, wherein the second classification network is a decoding network of an attention mechanism, and inputting the predicted image features into the second classification network to obtain the second network loss may include the following steps.

At S51, convolution processing is performed on the feature map of the sample image by using the second classification network, to obtain a plurality of attention centers.

In some possible implementations, the second classification network may be used to obtain a predicted feature map to perform the classification prediction result, that is, the second prediction result. The second classification network may perform convolution processing on the predicted feature map to obtain a plurality of attention centers (attention regions). The decoding network of the attention mechanism may predict important regions, i.e., the attention centers, in the image feature map through network parameters. During a continuous training process, accurate prediction of the attention centers may be implemented by adjusting the network parameters.

At S52, a second prediction result of each attention center among the plurality of attention centers is predicted.

After the plurality of attention centers is obtained, the prediction result corresponding to each attention center may be determined by means of classification prediction to obtain the corresponding object category. The second prediction result may include a second probability P_{x[k]} that the attention center is of each category (P_{x[k]} representing a second probability that the predicted category of the object in the attention center is k, and x represents a set of object categories.

At S53, the second network loss is obtained based on the second probability for each category in the second prediction result of each attention center.

After the second probability for each category in the second prediction result is obtained, the category of each object in the corresponding sample image is the category having the highest second probability for each attention center in the second prediction result. The second network loss may be obtained through the second probability of each attention center relative to each category, wherein a second loss function corresponding to the second classification network may be:

$${L}_{2} = \frac{exp ( {P}_{x [ class ]} )}{{\sum }_{k} exp ( {P}_{x [ k ]} )} \text{;}$$

where L₂ is the second network loss, P_{x[k]} represents the second probability that the category k is predicted in the second prediction result, and P_{x[class]} is the second probability, corresponding to the labeled category, in the second prediction result.

According to the foregoing embodiments, the first network loss and the second network loss may be obtained, and based on the first network loss and the second network loss, the overall network loss may be further obtained, thereby feeding back and adjusting the network parameters. The overall network loss may be obtained according to a weighted sum of the first network loss and the second network loss, wherein the weights of the first network loss and the second network loss may be determined according to a pre-configured weight, for example, the two may both be 1, or may also be other weight values, respectively. No specific limitation is made thereto in the present disclosure.

In some possible implementations, the overall network loss may also be determined in combination with other losses. In the process of training the network in the embodiments of the present disclosure, the method may further include: determining sample images with the same sequence as an image group; obtaining a feature center of a feature map corresponding to sample images in the image group; and determining a third predicted loss according to a distance between the feature map of a sample image in the image group and the feature center.

In some possible implementations, for each sample image, there may be a corresponding real labeled category, and the embodiments of the present disclosure may determine the sequences consisting of objects having the same real labeled category as the same sequences. Accordingly, sample images having the same sequences may be formed into one image group, and accordingly, at least one image group may be formed.

In some possible implementations, an average feature of the feature map of each sample image in each image group may be determined as the feature center, wherein the scale of the feature map of the sample image may be adjusted to the same scale, for example, pooling processing is performed on the feature map to obtain a feature map of a preset specification, so that the feature values of the same location may be averaged to obtain a feature center value of the same location. Accordingly, the feature center of each image group may be obtained.

In some possible implementations, after the feature center of the image group is obtained, the distance between each feature map and the feature center in the image group may be further determined to further obtain a third predicted loss.

The expression of the third predicted loss may include:

$${L}_{3} = \frac{1}{2} {\sum }_{h = 1}^{m} {‖ {f}_{h} - {f}_{y} ‖}_{2}^{2} \text{;}$$

where L₃ represents the third predicted loss, h is an integer greater than or equal to 1 and less than or equal to m, in represents the number of feature maps in the image group, fₕ represents the feature map of the sample image, and f_{y} represents the feature center. The third prediction loss may increase the feature distance between the categories, reduce the feature distance within the categories, and improve the prediction accuracy.

Accordingly, in the case that the third network loss is obtained, the network loss may also be obtained by using the weighted sum of the first network loss, the second network loss, and the third predicted loss, and parameters of the feature extraction network, the first classification network, and the second classification network are adjusted based on the network loss, until the training requirements are satisfied.

After the first network loss, the second network loss, and the third predicted loss are obtained, the overall loss of the network, i.e., the network loss, may be obtained according to the weighted sum of the predicted losses, and the network parameters are adjusted through the network loss. When the network loss is less than the loss threshold, it is determined that the training requirements are satisfied and the training is terminated. When the network loss is greater than or equal to the loss threshold, the network parameters in the network are adjusted until the training requirements are satisfied.

Based on the above configuration, in the embodiments of the present disclosure, supervised training of the network may be performed through two classification networks jointly. Compared with the training process by a single network, the accuracy of image features and classification prediction may be improved, thereby improving the accuracy of chip recognition on the whole. In addition, the object category may be obtained through the first classification network alone, or the final object category may be obtained by combining the recognition results of the first classification network and the second classification network, thereby improving the prediction accuracy.

Furthermore, when training the feature extraction network and the first classification network in the embodiments of the present disclosure, the training results of the first classification network and the second classification network may be combined to perform the training of the network, that is, when training the network, the accuracy of the network may further be improved by inputting the feature map into the second classification network, and training the network parameters of the entire network according to the prediction results of the first classification network and the second classification network. Since in the embodiments of the present disclosure, two classification networks may be used for joint supervised training when training the network, in actual applications, one of the first classification network and the second classification network may be used to obtain the object category in the to-be-recognized image.

In conclusion, in the embodiments of the present disclosure, it is possible to obtain a feature map of a to-be-recognized image by performing feature extraction on the to-be-recognized image, and obtain the category of each object in a sequence consisting of stacked objects in the to-be-recognized image according to the classification processing of the feature map. By means of the embodiments of the present disclosure, stacked objects in an image may be classified and recognized conveniently and accurately. In addition, in the embodiments of the present disclosure, supervised training of the network may be performed through two classification networks jointly. Compared with the training process by a single network, the accuracy of image features and classification prediction may be improved, thereby improving the accuracy of chip recognition on the whole.

It may be understood that the foregoing method embodiments mentioned in the present disclosure may be combined with each other to obtain a combined embodiment without departing from the principle and the logic. Details are not described in the present disclosure due to space limitation.

In addition, the present disclosure further provides an apparatus for recognizing stacked objects, an electronic device, a computer-readable storage medium, and a program. The above may be all used to implement any method for recognizing stacked objects provided in the present disclosure. For corresponding technical solutions and descriptions, refer to corresponding descriptions of the method section. Details are not described again.

A person skilled in the art can understand that, in the foregoing methods of the specific implementations, the order in which the steps are written does not imply a strict execution order which constitutes any limitation to the implementation process, and the specific order of executing the steps should be determined by functions and possible internal logics thereof.

FIG. 9 is a block diagram of an apparatus for recognizing stacked objects according to embodiments of the present disclosure. As shown in FIG. 9, the apparatus for recognizing stacked objects includes:

an obtaining module 10, configured to obtain a to-be-recognized image, wherein the to-be-recognized image includes a sequence formed by stacking at least one object along a stacking direction;

a feature extraction module 20, configured to perform feature extraction on the to-be-recognized image to obtain a feature map of the to-be-recognized image; and

a recognition module 30, configured to recognize a category of the at least one object in the sequence according to the feature map.

In some possible implementations, the to-be-recognized image includes an image of a surface of an object constituting the sequence along the stacking direction.

In some possible implementations, the at least one object in the sequence is a sheet-like object.

In some possible implementations, the stacking direction is a thickness direction of the sheet-like object in the sequence.

In some possible implementations, a surface of the at least one object in the sequence along the stacking direction has a set identifier, and the identifier includes at least one of a color, a texture, or a pattern.

In some possible implementations, the to-be-recognized image is cropped from an acquired image, and one end of the sequence in the to-be-recognized image is aligned with one edge of the to-be-recognized image.

In some possible implementations, the recognition module is further configured to: in the case of recognizing the category of at least one object in the sequence, determine a total value represented by the sequence according to a correspondence between the category and a value represented by the category.

In some possible implementations, the function of the apparatus is implemented by a neural network, the neural network includes a feature extraction network and a first classification network, the function of the feature extraction module is implemented by the feature extraction network, and the function of the recognition module is implemented by the first classification network;

the feature extraction module is configured to:

perform feature extraction on the to-be-recognized image by using the feature extraction network to obtain the feature map of the to-be-recognized image; and

the recognition module is configured to:

determine the category of the at least one object in the sequence by using the first classification network according to the feature map.

In some possible implementations, the neural network further includes the at least one second classification network, the function of the recognition module is further implemented by the second classification network, a mechanism of the first classification network for classifying the at least one object in the sequence according to the feature map is different from a mechanism of the second classification network for classifying the at least one object in the sequence according to the feature map, and the method further includes:

determining the category of the at least one object in the sequence by using the second classification network according to the feature map; and

determining the category of the at least one object in the sequence based on the category of the at least one object in the sequence determined by the first classification network and the category of the at least one object in the sequence determined by the second classification network.

In some possible implementations, the recognition module is further configured to: in the case that the number of object categories obtained by the first classification network is the same as the number of object categories obtained by the second classification network, compare the category of the at least one object obtained by the first classification network with the category of the at least one object obtained by the second classification network;

in the case that the first classification network and the second classification network have the same predicted category for an object, determine the predicted category as a category corresponding to the object; and

in the case that the first classification network and the second classification network have different predicted categories for an object, determine a predicted category with a higher predicted probability as the category corresponding to the object.

In some possible implementations, the recognition module is further configured to: in the case that the number of the object categories obtained by the first classification network is different from the number of the object categories obtained by the second classification network, determine the category of the at least one object predicted by a classification network with a higher priority in the first classification network and the second classification network as the category of the at least one object in the sequence.

In some possible implementations, the recognition module is further configured to: obtain a first confidence of a predicted category of the first classification network for the at least one object in the sequence based on the product of predicted probabilities of the predicted category of the first classification network for the at least one object, and obtain a second confidence of a predicted category of the second classification network for the at least one object in the sequence based on the product of predicted probabilities of the predicted category of the second classification network for the at least one object; and determine the predicted category of the at least one object corresponding to a larger value in the first confidence and the second confidence as the category of the at least one object in the sequence.

In some possible implementations, the apparatus further includes a training module, configured to train the neural network; the training module is configured to:

perform feature extraction on a sample image by using the feature extraction network to obtain a feature map of the sample image;

determine a predicted category of at least one object constituting a sequence in the sample image by using the first classification network according to the feature map;

determine a first network loss according to the predicted category of the at least one object determined by the first classification network and a labeled category of the at least one object constituting the sequence in the sample image; and

adjust network parameters of the feature extraction network and the first classification network according to the first network loss.

In some possible implementations, the neural network further includes at least one second classification network, and the training module is further configured to:

determine the predicted category of at least one object constituting the sequence in the sample image by using the second classification network according to the feature map; and

determine a second network loss according to the predicted category of the at least one object determined by the second classification network and the labeled category of the at least one object constituting the sequence in the sample image; and

the training module further configured to adjust the network parameters of the feature extraction network and the first classification network according to the first network loss, is configured to:

adjust network parameters of the feature extraction network, network parameters of the first classification network, and network parameters of the second classification network according to the first network loss and the second network loss respectively.

In some possible implementations, the training module is configured to adjust the network parameters of the feature extraction network, the network parameters of the first classification network, and the network parameters of the second classification network according to the first network loss and the second network loss respectively, is configured to: obtain a network loss by using a weighted sum of the first network loss and the second network loss, and adjust parameters of the feature extraction network, the first classification network, and the second classification network based on the network loss, until training requirements are satisfied.

In some possible implementations, the apparatus further includes a grouping module, configured to determining sample images with the same sequence as an image group; and

a determination module, configured to obtain a feature center of a feature map corresponding to sample images in the image group, wherein the feature center is an average feature of the feature map of sample images in the image group, and determine a third predicted loss according to a distance between the feature map of a sample image in the image group and the feature center; and

the training module configured to adjust the network parameters of the feature extraction network, the network parameters of the first classification network, and the network parameters of the second classification network according to the first network loss and the second network loss respectively, is configured to:

obtain a network loss by using a weighted sum of the first network loss, the second network loss, and the third predicted loss, and adjusting the parameters of the feature extraction network, the first classification network, and the second classification network based on the network loss, until the training requirements are satisfied.

In some possible implementations, the first classification network is a temporal classification neural network.

In some possible implementations, the second classification network is a decoding network of an attention mechanism. In some embodiments, functions or modules included in the apparatus provided in the embodiments of the present disclosure may be configured to perform the method described in the foregoing method embodiments. For specific implementation of the apparatus, reference may be made to descriptions of the foregoing method embodiments. For brevity, details are not described here again.

The embodiments of the present disclosure further provide a computer readable storage medium having computer program instructions stored thereon, where the foregoing method is implemented when the computer program instructions are executed by a processor. The computer readable storage medium may be a non-volatile computer readable storage medium.

The embodiments of the present disclosure further provide an electronic device, including: a processor; and a memory configured to store processor-executable instructions, where the processor is configured to execute the foregoing methods.

The electronic device may be provided as a terminal, a server, or devices in other forms.

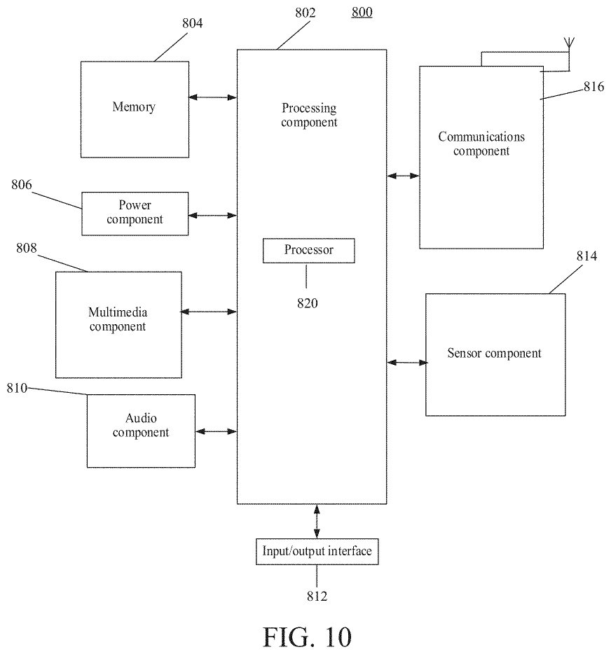

FIG. 10 is a block diagram of an electronic device according to embodiments of the present disclosure. For example, the electronic device 800 may be a terminal such as a mobile phone, a computer, a digital broadcast terminal, a message transceiver device, a game console, a tablet device, a medical device, a fitness device, or a personal digital assistant.

Referring to FIG. 10, the electronic device 800 may include one or more of the following components: a processing component 802, a memory 804, a power supply component 806, a multimedia component 808, an audio component 810, an Input/Output (I/O) interface 812, a sensor component 814, and a communications component 816.

The processing component 802 usually controls the overall operation of the electronic device 800, such as operations associated with display, telephone call, data communication, a camera operation, or a recording operation. The processing component 802 may include one or more processors 820 to execute instructions, to complete all or some of the steps of the foregoing method. In addition, the processing component 802 may include one or more modules, for convenience of interaction between the processing component 802 and other components. For example, the processing component 802 may include a multimedia module, for convenience of interaction between the multimedia component 808 and the processing component 802.

The memory 804 is configured to store data of various types to support an operation on the electronic device 800. For example, the data includes instructions, contact data, phone book data, a message, an image, or a video of any application program or method that is operated on the electronic device 800. The memory 804 may be implemented by any type of volatile or non-volatile storage device or a combination thereof, such as a Static Random Access Memory (SRAM), an Electrically Erasable Programmable Read-Only Memory (EEPROM), an Erasable Programmable Read-Only Memory (EPROM), a Programmable Read-Only Memory (PROM), a Read-Only Memory (ROM), a magnetic memory, a flash memory, a magnetic disk, or an optical disc.

The power supply component 806 supplies power to various components of the electronic device 800. The power supply component 806 may include a power management system, one or more power supplies, and other components associated with power generation, management, and allocation for the electronic device 800.

The multimedia component 808 includes a screen that provides an output interface and is between the electronic device 800 and a user. In some embodiments, the screen may include a Liquid Crystal Display (LCD) and a Touch Panel (TP). If the screen includes the touch panel, the screen may be implemented as a touchscreen, to receive an input signal from the user. The touch panel includes one or more touch sensors to sense a touch, a slide, and a gesture on the touch panel. The touch sensor may not only sense a boundary of a touch operation or a slide operation, but also detect duration and pressure related to the touch operation or the slide operation. In some embodiments, the multimedia component 808 includes a front-facing camera and/or a rear-facing camera. When the electronic device 800 is in an operation mode, for example, a photographing mode or a video mode, the front-facing camera and/or the rear-facing camera may receive external multimedia data. Each front-facing camera or rear-facing camera may be a fixed optical lens system that has a focal length and an optical zoom capability.

The audio component 810 is configured to output and/or input an audio signal. For example, the audio component 810 includes one microphone (MIC). When the electronic device 800 is in an operation mode, such as a call mode, a recording mode, or a voice recognition mode, the microphone is configured to receive an external audio signal. The received audio signal may be further stored in the memory 804 or sent by using the communications component 816. In some embodiments, the audio component 810 further includes a speaker, configured to output an audio signal.

The I/O interface 812 provides an interface between the processing component 802 and a peripheral interface module, and the peripheral interface module may be a keyboard, a click wheel, a button, or the like. These buttons may include, but are not limited to, a home button, a volume button, a startup button, and a lock button.

The sensor component 814 includes one or more sensors, and is configured to provide status evaluation in various aspects for the electronic device 800. For example, the sensor component 814 may detect an on/off state of the electronic device 800 and relative positioning of components, and the components are, for example, a display and a keypad of the electronic device 800. The sensor component 814 may also detect a location change of the electronic device 800 or a component of the electronic device 800, existence or nonexistence of contact between the user and the electronic device 800, an orientation or acceleration/deceleration of the electronic device 800, and a temperature change of the electronic device 800. The sensor component 814 may include a proximity sensor, configured to detect existence of a nearby object when there is no physical contact. The sensor component 814 may further include an optical sensor, such as a CMOS or CCD image sensor, configured for use in imaging application. In some embodiments, the sensor component 814 may further include an acceleration sensor, a gyro sensor, a magnetic sensor, a pressure sensor, or a temperature sensor.

The communications component 816 is configured for wired or wireless communication between the electronic device 800 and other devices. The electronic device 800 may be connected to a communication-standard-based wireless network, such as Wi-Fi, 2G or 3G, or a combination thereof. In an exemplary embodiment, the communications component 816 receives a broadcast signal or broadcast-related information from an external broadcast management system through a broadcast channel. In an exemplary embodiment, the communications component 816 further includes a Near Field Communication (NFC) module, to facilitate short-range communication. For example, the NFC module is implemented based on a Radio Frequency Identification (RFID) technology, an Infrared Data Association (IrDA) technology, an Ultra Wideband (UWB) technology, a Bluetooth (BT) technology, and other technologies.

In an exemplary embodiment, the electronic device 800 may be implemented by one or more of an Application Specific Integrated Circuit (ASIC), a Digital Signal Processor (DSP), a Digital Signal Processing Device (DSPD), a Programmable Logic Device (PLD), a Field Programmable Gate Array (FPGA), a controller, a microcontroller, a microprocessor, or other electronic components, and is configured to perform the foregoing method.

In an exemplary embodiment, a non-volatile computer readable storage medium, for example, the memory 804 including computer program instructions, is further provided. The computer program instructions may be executed by the processor 820 of the electronic device 800 to complete the foregoing method.

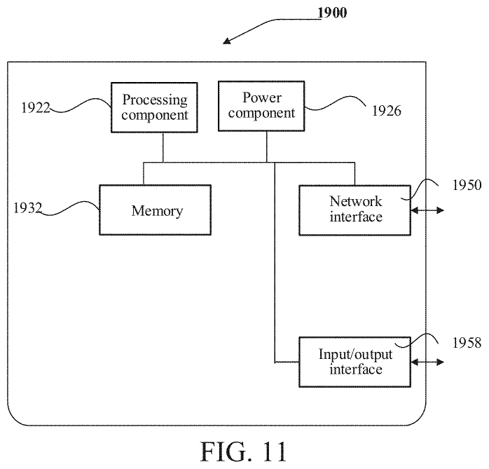

FIG. 11 is a block diagram of another electronic device according to embodiments of the present disclosure. For example, the electronic device 1900 may be provided as a server. Referring to FIG. 11, the electronic device 1900 includes a processing component 1922 that further includes one or more processors; and a memory resource represented by a memory 1932, configured to store instructions, for example, an application program, that may be executed by the processing component 1922. The application program stored in the memory 1932 may include one or more modules each corresponding to a set of instructions. In addition, the processing component 1922 is configured to execute the instructions to perform the foregoing method.

The electronic device 1900 may further include: a power supply component 1926, configured to perform power management of the electronic device 1900; a wired or wireless network interface 1950, configured to connect the electronic device 1900 to a network; and an Input/Output (I/O) interface 1958. The electronic device 1900 may operate an operating system stored in the memory 1932, such as Windows Server™ Mac OS X™ Unix™, Linux™, or FreeBSD™.

In an exemplary embodiment, a non-volatile computer readable storage medium, for example, the memory 1932 including computer program instructions, is further provided. The computer program instructions may be executed by the processing component 1922 of the electronic device 1900 to complete the foregoing method.

The present disclosure may be a system, a method, and/or a computer program product. The computer program product may include a computer readable storage medium, and computer readable program instructions that are used by the processor to implement various aspects of the present disclosure are loaded on the computer readable storage medium.

The computer readable storage medium may be a tangible device that can maintain and store instructions used by an instruction execution device. The computer-readable storage medium may be, but is not limited to, an electronic storage device, a magnetic storage device, an optical storage device, an electromagnetic storage device, a semiconductor storage device, or any suitable combination of the above ones. More specific examples (a non-exhaustive list) of the computer readable storage medium include a portable computer disk, a hard disk, a Random Access Memory (RAM), a Read-Only Memory (ROM), an Erasable Programmable Read-Only Memory (EPROM or flash memory), a Static Random Access Memory (SRAM), a portable Compact Disc Read-Only Memory (CD-ROM), a Digital Versatile Disk (DVD), a memory stick, a floppy disk, a mechanical coding device such as a punched card storing instructions or a protrusion structure in a groove, and any appropriate combination thereof. The computer readable storage medium used here is not interpreted as an instantaneous signal such as a radio wave or another freely propagated electromagnetic wave, an electromagnetic wave propagated by a waveguide or another transmission medium (for example, an optical pulse transmitted by an optical fiber cable), or an electrical signal transmitted by a wire.

The computer readable program instructions described here may be downloaded from a computer readable storage medium to each computing/processing device, or downloaded to an external computer or an external storage device via a network, such as the Internet, a local area network, a wide area network, and/or a wireless network. The network may include a copper transmission cable, optical fiber transmission, wireless transmission, a router, a firewall, a switch, a gateway computer, and/or an edge server. A network adapter or a network interface in each computing/processing device receives the computer readable program instructions from the network, and forwards the computer readable program instructions, so that the computer readable program instructions are stored in a computer readable storage medium in each computing/processing device.

Computer program instructions for carrying out operations of the present disclosure may be assembler instructions, Instruction-Set-Architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The program readable program instructions may be completely executed on a user computer, partially executed on a user computer, executed as an independent software package, executed partially on a user computer and partially on a remote computer, or completely executed on a remote computer or a server. In the case of a remote computer, the remote computer may be connected to a user computer via any kind of network, including a Local Area Network (LAN) or a Wide Area Network (WAN), or may be connected to an external computer (for example, connected via the Internet with the aid of an Internet service provider). In some embodiments, an electronic circuit such as a programmable logic circuit, a Field Programmable Gate Array (FPGA), or a Programmable Logic Array (PLA) is personalized by using status information of the computer readable program instructions, and the electronic circuit may execute the computer readable program instructions to implement various aspects of the present disclosure.

Various aspects of the present disclosure are described here with reference to the flowcharts and/or block diagrams of the methods, apparatuses (systems), and computer program products according to the embodiments of the present disclosure. It should be understood that each block in the flowcharts and/or block diagrams and a combination of the blocks in the flowcharts and/or block diagrams may be implemented by using the computer readable program instructions.

These computer readable program instructions may be provided for a general-purpose computer, a dedicated computer, or a processor of another programmable data processing apparatus to generate a machine, so that when the instructions are executed by the computer or the processor of the another programmable data processing apparatus, an apparatus for implementing a specified function/action in one or more blocks in the flowcharts and/or block diagrams is generated. These computer readable program instructions may also be stored in a computer readable storage medium, and these instructions may instruct a computer, a programmable data processing apparatus, and/or another device to work in a specific manner. Therefore, the computer readable storage medium storing the instructions includes an artifact, and the artifact includes instructions for implementing a specified function/action in one or more blocks in the flowcharts and/or block diagrams.

The computer readable program instructions may be loaded onto a computer, another programmable data processing apparatus, or another device, so that a series of operations and steps are executed on the computer, the another programmable apparatus, or the another device, thereby generating computer-implemented processes. Therefore, the instructions executed on the computer, the another programmable apparatus, or the another device implement a specified function/action in one or more blocks in the flowcharts and/or block diagrams.

The flowcharts and block diagrams in the accompanying drawings show possible architectures, functions, and operations of the systems, methods, and computer program products in the embodiments of the present disclosure. In this regard, each block in the flowcharts or block diagrams may represent a module, a program segment, or a part of instruction, and the module, the program segment, or the part of instruction includes one or more executable instructions for implementing a specified logical function. In some alternative implementations, functions marked in the block may also occur in an order different from that marked in the accompanying drawings. For example, two consecutive blocks are actually executed substantially in parallel, or are sometimes executed in a reverse order, depending on the involved functions. It should also be noted that each block in the block diagrams and/or flowcharts and a combination of blocks in the block diagrams and/or flowcharts may be implemented by using a dedicated hardware-based system that executes a specified function or action, or may be implemented by using a combination of dedicated hardware and a computer instruction.

The embodiments of the present disclosure are described above. The foregoing descriptions are exemplary but not exhaustive, and are not limited to the disclosed embodiments. For a person of ordinary skill in the art, many modifications and variations are all obvious without departing from the scope and spirit of the described embodiments. The terms used herein are intended to best explain the principles of the embodiments, practical applications, or technical improvements to the technologies in the market, or to enable other persons of ordinary skill in the art to understand the embodiments disclosed herein.

1. A method for recognizing stacked objects, comprising:
obtaining a to-be-recognized image, wherein the to-be-recognized image comprises a sequence formed by stacking at least one object along a stacking direction;
performing feature extraction on the to-be-recognized image to obtain a feature map of the to-be-recognized image; and
recognizing a category of the at least one object in the sequence according to the feature map.

2. The method according to claim 1, wherein the to-be-recognized image comprises an image of a surface of an object constituting the sequence along the stacking direction,
the at least one object in the sequence is a sheet-like object,
the stacking direction is a thickness direction of the sheet-like object in the sequence, and
a surface of the at least one object in the sequence along the stacking direction has a set identifier, and the identifier comprises at least one of a color, a texture, or a pattern.

3. The method according to claim 1, wherein the to-be-recognized image is cropped from an acquired image, and one end of the sequence in the to-be-recognized image is aligned with one edge of the to-be-recognized image.

4. The method according to claim 1, further comprising:
in the case of recognizing the category of at least one object in the sequence, determining a total value represented by the sequence according to a correspondence between the category and a value represented by the category.

5. The method according to claim 1, wherein the method is implemented by a neural network, and the neural network comprises a feature extraction network and a first classification network;
performing feature extraction on the to-be-recognized image to obtain the feature map of the to-be-recognized image comprises:
performing feature extraction on the to-be-recognized image by using the feature extraction network to obtain the feature map of the to-be-recognized image; and
recognizing the category of the at least one object in the sequence according to the feature map comprises:
determining the category of the at least one object in the sequence by using the first classification network according to the feature map.

6. The method according to claim 5, wherein the neural network further comprises a second classification network, a mechanism of the first classification network for classifying the at least one object in the sequence according to the feature map is different from a mechanism of the second classification network for classifying the at least one object in the sequence according to the feature map, and the method further comprises:
determining the category of the at least one object in the sequence by using the second classification network according to the feature map; and
determining the category of the at least one object in the sequence based on the category of the at least one object in the sequence determined by the first classification network and the category of the at least one object in the sequence determined by the second classification network.

7. The method according to claim 6, wherein determining the category of the at least one object in the sequence based on the category of the at least one object in the sequence determined by the first classification network and the category of the at least one object in the sequence determined by the second classification network comprises:
in response to the number of object categories obtained by the first classification network being the same as the number of object categories obtained by the second classification network, comparing the category of the at least one object obtained by the first classification network with the category of the at least one object obtained by the second classification network; in the case that the first classification network and the second classification network have the same predicted category for an object, determining the predicted category as a category corresponding to the object; and in the case that the first classification network and the second classification network have different predicted categories for an object, determining a predicted category with a higher predicted probability as the category corresponding to the object; and/or
in response to the number of the object categories obtained by the first classification network being different from the number of the object categories obtained by the second classification network, determining the category of the at least one object predicted by a classification network with a higher priority in the first classification network and the second classification network as the category of the at least one object in the sequence; and/or
obtaining a first confidence of a predicted category of the first classification network for the at least one object in the sequence based on the product of predicted probabilities of the predicted category of the first classification network for the at least one object, and obtaining a second confidence of a predicted category of the second classification network for the at least one object in the sequence based on the product of predicted probabilities of the predicted category of the second classification network for the at least one object; and determining the predicted category of the object corresponding to a larger value in the first confidence and the second confidence as the category of the at least one object in the sequence.

8. The method according to claim 6, wherein a process of training the neural network comprises:
performing feature extraction on a sample image by using the feature extraction network to obtain a feature map of the sample image;
determining a predicted category of at least one object constituting a sequence in the sample image by using the first classification network according to the feature map;
determining a first network loss according to the predicted category of the at least one object determined by the first classification network and a labeled category of the at least one object constituting the sequence in the sample image; and
adjusting network parameters of the feature extraction network and the first classification network according to the first network loss.

9. The method according to claim 8, wherein the neural network further comprises at least one second classification network, and the process of training the neural network further comprises:
determining the predicted category of at least one object constituting the sequence in the sample image by using the second classification network according to the feature map; and
determining a second network loss according to the predicted category of the at least one object determined by the second classification network and the labeled category of the at least one object constituting the sequence in the sample image; and
adjusting network parameters of the feature extraction network and the first classification network according to the first network loss comprises:
adjusting network parameters of the feature extraction network, network parameters of the first classification network, and network parameters of the second classification network according to the first network loss and the second network loss respectively.

10. The method according to claim 9, further comprising:
determining sample images with the same sequence as an image group;
obtaining a feature center of a feature map corresponding to sample images in the image group, Wherein the feature center is an average feature of the feature map of sample images in the image group; and
determining a third predicted loss according to a distance between the feature map of a sample image in the image group and the feature center; and
adjusting network parameters of the feature extraction network, network parameters of the first classification network, and network parameters of the second classification network according to the first network loss and the second network loss respectively comprises:
obtaining a network loss by using a weighted sum of the first network loss, the second network loss, and the third predicted loss, and adjusting the parameters of the feature extraction network, the first classification network, and the second classification network based on the network loss, until the training requirements are satisfied.

11. An apparatus for recognizing stacked objects, comprising:
a processor; and
a memory configured to store processor executable instructions;
wherein the processor is configured to invoke the instructions stored in the memory, to:
obtain a to-be-recognized image, wherein the to-be-recognized image comprises a sequence formed by stacking at least one object along a stacking direction;
perform feature extraction on the to-be-recognized image to obtain a feature snap of the to-be-recognized image; and
recognize a category of the at least one object in the sequence according to the feature map.

12. The apparatus according to claim 11, wherein the to-be-recognized image is cropped capturing from an acquired image, and one end of the sequence in the to-be-recognized image is aligned with one edge of the to-be-recognized image.

13. The apparatus according to claim 11, wherein the processor is further configured to:
in the case of recognizing the category of at least one object in the sequence, determine a total value represented by the sequence according to a correspondence between the category and a value represented by the category.

14. The apparatus according to claim 11, wherein the function of the apparatus is implemented by a neural network, the neural network comprises a feature extraction network and a first classification network;
performing feature extraction on the to-be-recognized image to obtain the feature map of the to-be-recognized image comprises:
performing feature extraction on the to-be-recognized image by using the feature extraction network to obtain the feature map of the to-be-recognized image; and
recognizing the category of the at least one object in the sequence according to the feature map comprises:
determining the category of the at least one object in the sequence by using the first classification network according to the feature map.

15. The apparatus according to claim 14, wherein the neural network further comprises a second classification network, a mechanism of the first classification network for classifying the at least one object in the sequence according to the feature map is different from a mechanism of the second classification network for classifying the at least one object in the sequence according to the feature map; and the processor is further configured to:
determine the category of the at least one object in the sequence by using the second classification network according to the feature map; and
determine the category of the at least one object in the sequence based on the category of the at least one object in the sequence determined by the first classification network and the category of the at least one object in the sequence determined by the second classification network.

16. The apparatus according to claim 15, wherein determining the category of the at least one object in the sequence based on the category of the at least one object in the sequence determined by the first classification network and the category of the at least one object in the sequence determined by the second classification network comprises:
in the case that the number of object categories obtained by the first classification network is the same as the number of object categories obtained by the second classification network, comparing the category of the at least one object obtained by the first classification network with the category of the at least one object obtained by the second classification network: in the case that the first classification network and the second classification network have the same predicted category for an object, determining the predicted category as a category corresponding to the object; and in the case that the first classification network and the second classification network have different predicted categories for an object, determining a predicted category with a higher predicted probability as the category corresponding to the object; and/or
in the case that the number of the object categories obtained by the first classification network is different from the number of the object categories obtained by the second classification network, determining the category of the at least one object predicted by a classification network with a higher priority in the first classification network and the second classification network as the category of the at least one object in the sequence; and/or
obtaining a first confidence of a predicted category of the first classification network for the at least one object in the sequence based on the product of predicted probabilities of the predicted category of the first classification network for the at least one object, and obtaining a second confidence of a predicted category of the second classification network for the at least one object in the sequence based on the product of predicted probabilities of the predicted category of the second classification network for the at least one object; and determining the predicted category of the object corresponding to a larger value in the first confidence and the second confidence as the category of the at least one object in the sequence.

17. The apparatus according to claim 15, wherein the processor is further configured to train the neural network,
training the neural network comprises:
performing feature extraction on a sample image by using the feature extraction network to obtain a feature map of the sample image;
determining a predicted category of at least one object constituting a sequence in the sample image by using the first classification network according to the feature map;
determining a first network loss according to the predicted category of the at least one object determined by the first classification network and a labeled category of the at least one object constituting the sequence in the sample image; and
adjusting network parameters of the feature extraction network and the first classification network according to the first network loss.

18. The apparatus according to claim 17, wherein the neural network further comprises at least one second classification network, and training the neural network further comprises:
determining the predicted category of at least one object constituting the sequence in the sample image by using the second classification network according to the feature map; and
determining a second network loss according to the predicted category of the at least one object determined by the second classification network and the labeled category of the at least one object constituting the sequence in the sample image; and
adjusting network parameters of the feature extraction network and the first classification network according to the first network loss comprises:
adjusting network parameters of the feature extraction network, network parameters of the first classification network, and network parameters of the second classification network according to the first network loss and the second network loss respectively.

19. The apparatus according to claim 18, wherein the processor is further configured to:
determine sample images with the same sequence as an image group; and
obtain a feature center of a feature map corresponding to sample images in the image group, wherein the feature center is an average feature of the feature map of sample images in the image group, and determine a third predicted loss according to a distance between the feature map of a sample image in the image group and the feature center; and
wherein adjusting the network parameters of the feature extraction network, the network parameters of the first classification network, and the network parameters of the second classification network according to the first network loss and the second network loss respectively comprises:
obtaining a network loss by using a weighted sum of the first network loss, the second network loss, and the third predicted loss, and adjusting the parameters of the feature extraction network, the first classification network, and the second classification network based on the network loss, until the training requirements are satisfied.

20. A non-transitory computer-readable storage medium having computer program instructions stored thereon, wherein when the computer program instructions are executed by a processor, the processor is caused to:
obtain a to-be-recognized image, wherein the to-be-recognized image comprises a sequence formed by stacking at least one object along a stacking direction;
perform feature extraction on the to-be-recognized image to obtain a feature map of the to-be-recognized image; and
recognize a category of the at least one object in the sequence according to the feature map.
